(19) United States
(12) Patent Application Publication
(10) Pub. No.: US 2007/0132125 A1
(43) Pub. Date: Jun. 14, 2007

(54) Use of a super-cooled fluid in lens processing

(75) Inventors: Sanjay Rastogi, Rochester, NY (US); Gary Friends, Ontario, NY (US); Mahendra Nandu, Pittsford, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/598,357

(22) Filed: Nov. 13, 2006

Related U.S. Application Data
(60) Provisional application No. 60/748,457, filed on Dec. 8, 2005.

(51) Int. Cl. B29D 11/00

(52) U.S. Cl. 264/2.6; 264/2.7

(57) ABSTRACT

The present invention is a process for extracting pre-polymer from a polymer lens. The process comprises the step of contacting the lens with a super-cooled solvent for a period of time to increase the modulus of the contact lens. Thereafter the contact lens undergoes additional dry processing steps. By way of example, the dry processing steps include but are not limited to surface treatment, lens coating and polishing and/or edging of the contact lens.

### CROSS REFERENCE

This application claims the benefit of Provisional Patent Application No. 60/748,457 filed Dec. 8, 2005 and is incorporated herein by reference.

### BACKGROUND OF THE INVENTION

1. Field of the Invention

The present invention relates to processing of a contact lens and more particularly to processing of silicone hydrogel contact lenses.

2. Discussion of Related Art

Most contact lenses are molded in disposable polyethylene or polypropylene molds. Specifically, a contact lens is made of two mold halves. The anterior mold half defines the convex surface of the contact lens. The posterior mold half defines the concave surface of the contact lens. During the molding process, a predetermined amount of a pre-polymer mixture is placed in the anterior mold half. The posterior mold half is pressed against the anterior mold half forming the desired shape of the contact lens. After the mold halves are placed together, a curing step occurs. In one embodiment, the curing step occurs by application of ultraviolet light that catalyzes a polymerization reaction.

The contact lens is removed from the two disposable mold halves and further processed and packaged. The need for further processing depends in large part upon the nature of the lens that results from the molding process. Silicone hydrogel contact lenses and other high Dₖ polymers have a low modulus after being released from the mold and may be too flexible for additional processing. Additional processing optionally includes surface treatment and lens polishing/de-edging where the edge of the lens is contoured after molding to improve the comfort of the lens on the eye.

Modulus referred to above, is the measure of the stiffness of a material. A material that has a relatively low modulus is more flexible and pliable. A material that has a relatively high modulus is less flexible and pliable.

In some instances, removal of solvents from a newly formed polymer will have a limited effect of increasing modulus of the ophthalmic lens; the degree of change in modulus is limited. Otherwise, there is no way known to dramatically increase the modulus of the ophthalmic lens.

The casting of polymers in molds and the release of the cast materials from the molds is well established. It is also well established that increasing the modulus of the cast material facilitates the removal of the cast material from the mail. For example, it is known that cooling of the mold and/or the cast material not only increases the modulus of the material but also causes the cast material to shrink and separate from the mold, thereby facilitating removal of the cast material from the mold. See U.S. Pat. No. 5,259,998, incorporated by reference herein.

Cryogenic nitrogen, for example, has been used to cause lenses to shrink and separate from a mold. Similarly, it is known that materials cast in the presence of a solvent can be removed from molds by evaporating at least a portion of the solvent thereby causing the modulus of the cast material to increase and the material to shrink and separate from the mold. See Japan Publication No. 01152015, incorporated by reference herein.

It would be an advantage to be able to increase the modulus of the contact lens once it has been removed from a contact lens mold to facilitate additional processing steps. The present invention addresses these and other needs.

### SUMMARY OF THE INVENTION

The present invention is a process for manufacturing a contact lens comprising the steps of forming the contact lens in a mold. The contact lens is removed from the mold. The contact lens is contacted with a cryogenic solvent to increase the modulus of the contact lens. Additional dry processing steps are performed. By dry processing it is meant processing step of the contact lens before the contact lens is hydrated by a solvent including water. The additional dry processing step of one embodiment comprises coating the contact lens. In another embodiment, the additional dry processing is surface treating the contact lens. In yet another embodiment, the additional step comprises polishing the contact lens including the edge of the contact lens. By edge it is meant the circumference of the contact lens and the surface of the contact lens that has optical properties that are not critical for vision correction. In one embodiment it is preferable to be able to shape the edge of the contact lens without contacting the center of the contact lens. By the center of the contact lens it is meant the portion of the lens that has optical properties that are critical for vision correction. For example, when a contact lens is surface treated, polishing that is not specific to the edge of the lens can damage the surface treatment of the contact lens or remove the coating of the contact lens. Thus, a polishing step that is not specific to the edge and region about the edge cannot be performed after coating or surface treatment. In one embodiment, there is a process for finishing an ophthalmic lens. In one embodiment, the ophthalmic lens is an intra-ocular lens. In another embodiment, the ophthalmic lens is a contact lens. The process comprises the step of providing an ophthalmic lens. The polymeric medical device is contacted with a super cooled fluid to increase the modulus of the ophthalmic lens. The edge of the contact lens is finished.

In another embodiment, there is a process for making an ophthalmic lens. The process comprises providing a mold. The mold is filled with a pre-polymer. The pre-polymer is cured to form an ophthalmic lens. The ophthalmic lens is removed from the mold. The ophthalmic lens is contacted with a cryogenic solvent to increase the modulus of the contact lens. Additional dry processing steps are performed.

In one embodiment, the pre-polymer is a silicone containing pre-polymer. In another embodiment, the pre-polymer is a hydrophilic pre-polymer. In still another embodiment, at least one pre-polymer is selected from the group consisting of amide monomers such as N,N-dimethylacrylamide and N,N-dimethylmethacrylamide; cyclic lactam monomers-such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

In an embodiment, the contacting step occurs for a period of time that is a minimum of about 0.1 seconds and a maximum of about 20 seconds.

In an embodiment, the contacting occurs by immersing the contact lens in a bath containing the super-cooled fluid. Typically, the contacting occurs by spraying the super-cooled fluid over the contact lens. Alternatively, the contacting occurs by dispensing a measure of super-cooled fluid on the surface of the contact lens.

In one embodiment, the super-cooled fluid is at a temperature below about minus 40° C.

In still another embodiment, the super-cooled fluid is selected from the group consisting essentially of nitrogen, argon, helium, air and carbon dioxide.

In yet another embodiment, the step of contacting occurs after the ophthalmic lens is removed from a mold that forms the ophthalmic lens. Alternatively, the step of contacting occurs while the ophthalmic lens is being released from a mold that forms the ophthalmic lens.

In one embodiment, the ophthalmic lens is contacted with a super-cooled fluid before it is hydrated. In one embodiment, the ophthalmic lens has a modulus that is a minimum of about 20 g/mm², about 30 g/mm², about 40 g/mm², about 50 g/mm², about 75 g/mm², about 100 g/mm² and a maximum of about 200 g/mm², about 175 g/mm², about 150 g/mm², about 125 g/mm², about 100 g/mm², about 80 g/mm², about 75 g/mm² or about 70 g/mm² after the contact lens is hydrated.

### DETAILED DESCRIPTION OF THE INVENTION

One method in practice for making ophthalmic lenses including contact lenses and intraocular lenses is cast molding. Cast molding of ophthalmic lenses involves depositing a curable mixture of polymerizable lens materials, such as pre-polymers, in a mold cavity formed by two assembled mold sections, curing the mixture, disassembling the mold sections and removing the molded lens. As used herein, the term “pre-polymer” and like terms denote compounds that are inserted into an ophthalmic lens mold to be polymerized by free radical polymerization, the term includes monomers and macromonomers and related terms.

Other post-molding processing steps may also be employed. Representative cast molding methods are disclosed in U.S. Pat. No. 5,271,875 (Appleton et al.); U.S. Pat. No. 4,197,266 (Clark et al.); U.S. Pat. No. 4,208,364 (Shepherd); U.S. Pat. No. 4,865,779 (Ihn et al.); U.S. Pat. No. 4,955,580 (Seden et al.); U.S. Pat. No. 5,466,147 (Appleton et al.); and U.S. Pat. No. 5,143,660 (Hamilton et al.).

Cast molding occurs between a pair of mold sections. One mold section, referred to as the anterior mold section forms the anterior, convex, optical surface of the ophthalmic lens. The other mold section, referred to as the posterior mold section, forms the posterior, concave, optical surface of the ophthalmic lens. The anterior and posterior mold sections are generally complimentary in configuration.

Typically, a predetermined amount of a liquid mixture including uncured pre-polymer and solvent is placed in the anterior mold section. The posterior mold section is placed over the anterior mold section and takes the shape of the ophthalmic lens. If the desired lens is aspheric, the posterior mold section must be axially positioned relative to anterior mold halve to create proper aspheric shape. The predetermined amount is slightly greater than the volume of the ophthalmic lens mold. A small portion of the pre-polymer mixture overflows in a radially spaced apart overflow reservoir that surrounds the circumference of the ophthalmic lens. Then, the ophthalmic lens is cured by a curing technique such as exposure to ultraviolet radiation.

Once the ophthalmic lens is formed, the mold sections are separated and the molded ophthalmic lens is removed in a multi-step process. The anterior and posterior mold sections are usually used only once for casting an ophthalmic lens prior to being discarded due to the significant degradation of the optical surfaces of the mold sections that often occurs during a single casting operation.

Mold/Mold Half Formation

Formation of the mold sections used in casting occurs through a separate molding process prior to cast molding. In this regard, the mold sections are first formed by injection molding a resin in the cavity of an injection molding apparatus.

Ophthalmic Lens Materials and their Monomeric Precursors

Hydrogels represent one class of materials used for many device applications, including ophthalmic lenses that are made by the molding process. Hydrogels comprise a hydrated, cross-linked polymeric systems containing water in an equilibrium state. Accordingly, hydrogels are copolymers prepared from hydrophilic pre-polymers. In the case of silicone hydrogels, the hydrogel copolymers are generally prepared by polymerizing a mixture containing at least one device-forming silicone-containing pre-polymer and at least one device-forming hydrophilic pre-polymer. Either the silicone-containing pre-polymer or the hydrophilic pre-polymer may function as a crosslinking agent (a crosslinking agent being defined as a pre-polymer having multiple polymerizable functionalities), or alternately, a separate crosslinking agent may be employed in the initial pre-polymer mixture from which the hydrogel copolymer is formed. Silicone hydrogels typically have a water-content that is a minimum of about 10 wt. % and a maximum of about 80 wt. %.

Examples of useful device-forming hydrophilic pre-polymers include: amides such as N,N-dimethylacrylamide and N,N-dimethylmethacrylamide; cyclic lactams such as N-vinyl-2-pyrrolidone; (meth)acrylated alcohols, such as 2-hydroxyethylmethacrylte and 2-hydroxyethylacrylate; and (meth)acrylated poly(alkene glycols), such as poly(diethylene glycols) of varying chain length containing monomethacrylate or dimethacrylate end caps. Still further examples are the hydrophilic vinyl carbonate or vinyl carbamate pre-polymers disclosed in U.S. Pat. No. 5,070,215, and the hydrophilic oxazolone pre-polymers disclosed in U.S. Pat. No. 4,910,277, the disclosures of which are incorporated herein by reference. Other suitable hydrophilic pre-polymers will be apparent to one skilled in the art.

As mentioned, one preferred class hydrogel contact lens materials is silicone hydrogels. In this case, the initial lens-forming monomer mixture further comprises a silicone-containing monomer.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779 and 5,358,995.

Examples of applicable silicon-containing monomers include bulky polysiloxanylalkyl (meth)acrylic monomers. An example of bulky polysiloxanylalkyl (meth)acrylic monomers are represented by the following Formula I: 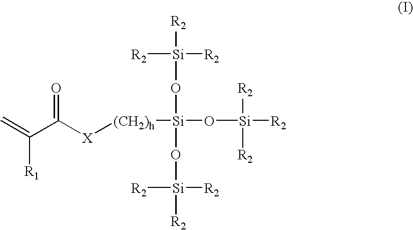
wherein:

X denotes —O— or —NR—;

each R₁ independently denotes hydrogen or methyl;

each R₂ independently denotes a lower alkyl radical, phenyl radical or a group represented by

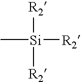

wherein each R′₂ independently denotes a lower alkyl or phenyl radical; and h is 1 to 10. One preferred bulky monomer is methacryloxypropyl tris(trimethyl-siloxy)silane or tris(trimethylsiloxy)silylpropyl methacrylate, sometimes referred to as TRIS.

Another class of representative silicon-containing monomers includes silicone-containing vinyl carbonate or vinyl carbamate monomers such as: 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(tri-methylsiloxy)silyl] propyl vinyl carbamate; 3-[tris(trimethylsiloxy)silyl] propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicon-containing vinyl carbonate or vinyl carbamate monomers are represented by Formula II: 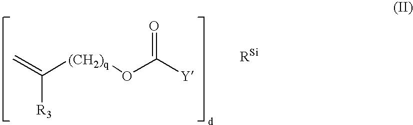
wherein:

Y′ denotes —O—, —S— or —NH—;

R^{Si} denotes a silicone-containing organic radical;

R₃ denotes hydrogen or methyl;

d is 1, 2, 3 or 4; and q is 0 or 1.

Suitable silicone-containing organic radicals R^{Si} include the following:
—(CH₂)_{n′}Si[(CH₂)_{m′}CH₃]₃;
—(CH₂)_{n′}Si[OSi(CH₂)_{m′}CH₃]₃; 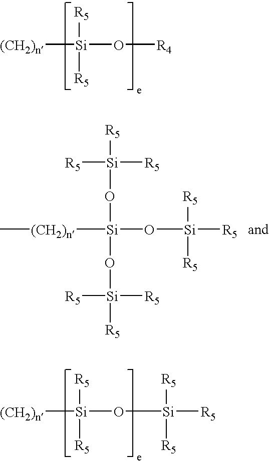
wherein:

R₄ denotes 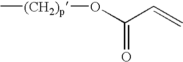
wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

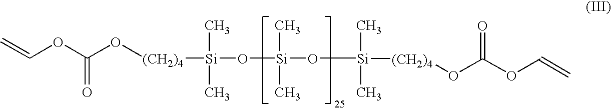

Another class of silicon-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:
E(*D*A*D*G)ₐ*D*A*D*E′; or (IV)
E(*D*G*D*A)ₐ*D*G*D*E′; (V)
wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of Formula VI: 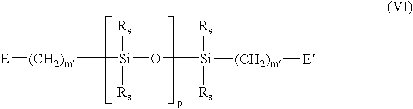
wherein:
each Rₛ independently denotes an alkyl or fluoro-substituted alkyl group having 1 to 10 carbon atoms which may contain ether linkages between carbon atoms;
m′ is at least 1; and
p is a number which provides a moiety weight. of 400 to 10,000;
each of E and E′ independently denotes a polymerizable unsaturated organic radical represented by Formula VII: 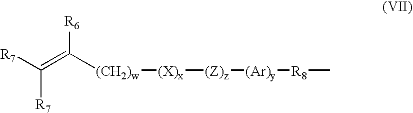
wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

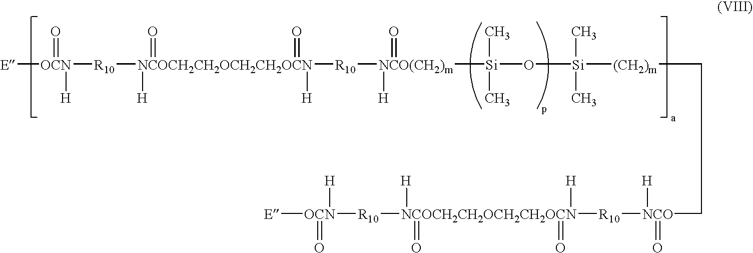

wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

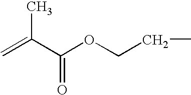

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

Specific examples of contact lens materials useful in the present invention are taught in U.S. Pat. No. 6,891,010 (Kunzler et al.); U.S. Pat. No. 5,908,906 (Kunzler et al.); U.S. Pat. No. 5,714,557 (Kunzler et al.); U.S. Pat. No. 5,710,302 (Kiinzler et al.); U.S. Pat. No. 5,708,094 (Lai et al.); U.S. Pat. No. 5,616,757 (Bambury et al.); U.S. Pat. No. 5,610,252 (Bambury et al.); U.S. Pat. No. 5,512,205 (Lai); U.S. Pat. No. 5,449,729 (Lai); U.S. Pat. No. 5,387,662 (Kunzler et al.); U.S. Pat. No. 5,310,779 (Lai); and U.S. Pat. No. 5,346,976 (Ellis et al.); the disclosures of which are incorporated herein by reference.

In one embodiment, the hydrogel pre-polymer mixture includes a solvent or diluent. Preferably, an organic diluent is included in the initial pre-polymer mixture. As used herein, the term “organic diluent” encompasses organic compounds that are substantially unreactive with the components in the initial mixture, and are often used to minimize incompatibility of the pre-polymer components in this mixture. Representative organic diluents include: monohydric alcohols, such as C₆-C₁₀ monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene.

Curing

Once the mold unit has been assembled it is subjected to a curing cycle, which polymerizes the pre-polymer inside the mold cavity. Typical contact lens curing methods involve exposing the pre-polymer mixture to light radiation (such as UV radiation or visible light) and/or thermal energy (e.g. oven curing). The result is an ophthalmic contact lens that forms the shape of the mold.

In one embodiment, the ophthalmic lens is contacted with a super-cooled fluid before it is hydrated. In one embodiment, the ophthalmic lens has a modulus that is a minimum of about 20 g/mm², about 30 g/mm², about 40 g/mm², about 50 g/mm2, about 75 g/mm², about 100 g/mm² and a maximum of about 200 g/mm², about 175 g/mm², about 150 g/mm², about 125 g/mm², about 100 g/mm², about 80 g/mm², about 75 g/mm² or about 70 g/mm² after the contact lens is hydrated. Typically a medium modulus lens has a modulus that is a minimum of about 75 g/mm² and a maximum of about 150 g/mm² after the contact lens is hydrated. A low modulus lens has a modulus that is a maximum of about 70 g/mm . In one embodiment, the ophthalmic lens has a Dₖ that is a minimum of about 80, about 900, about 100, about 120, about 130 or about 140 after the ophthalmic lens is hydrated.

Modulus and elongation tests are conducted according to ASTM D-1708a, employing an Instron (Model 4502) instrument where the hydrogel film sample is immersed in borate buffered saline; an appropriate size of the film sample is gauge length 22 mm and width 4.75 mm, where the sample fuirther has ends forming a dogbone shape to accommodate gripping of the sample with clamps of the Instron instrument, and a thickness of 200±50 microns.

De-Capping

Once curing is complete, the posterior mold section is separated from the anterior mold section to reveal the lens formed therein. The mold release process must break the adhesive bond between the mold sections, yet not damage the lens, which remains on one of the mold surfaces. In a preferred embodiment the lens remains upon the anterior-concave optical surface at mold release and the annular lens flash remains or reservoir with the associated posterior mold section. According to one embodiment, the step of decapping occurs with the aid of a super-cooled fluid according to the teaching of corresponding U.S. Application No. 60/638,893 filed Dec. 22, 2004 entitled, “Pre-Polymer Extraction Using a Super-Cooled Fluid,” which is incorporated herein by reference in its entirety.

Solvent Removal

An optional step following de-capping is solvent removal. Unreacted solvent can be removed from the molded ophthalmic lens to further stiffen the lens. Preferably, solvents are volatile thus exposure to air at room temperature for a period of time will remove solvent. Nonetheless, a solvent can be removed in less time by placing the lens in an oven. After the solvent is evaporated from the lens, the lens is removed from the oven for additional processing. The step of solvent removal is preferably performed after the de-capping step and before reservoir removal. Optionally, the step of solvent removal can occur after reservoir removal, but before lens extraction.

Reservoir Removal

The manufacturing line may comprise a reservoir removal station to ensure the lens flash or reservoir is removed from the anterior mold section. The removal station may conveniently comprise a knife blade, which strips the annular lens flash or reservoir from the top of the mold section. Thus, immediately following mold release, the lens remains bonded to the concave mold surface and it is in the dry, rigid state. Alternatively, the step of reservoir removal by creating a temperature differential between the contact lens and the reservoir with the aid of a super-cooled fluid according to the teaching of corresponding U.S. Application No. 60/638,893 filed Dec. 22, 2004 entitled, “Pre-Polymer Extraction Using a Super-Cooled Fluid,” which is incorporated herein by reference in its entirety.

Lens Release

Next, the lens is released from the mold half to which it is attached. The lens is released in a “wet release” process by hydrating the lens. Generally, hydration occurs when the lens is immersed in a water bath. However, a wet release step at this stage prevents one or more additional processing steps including polishing and edging.

Preferably, the lens is dry released (i.e. released from the mold without hydration of the lens) by applying a force angular to the axis of the contact lens and mold half to separate the ophthalmic lens from the mold half.

In one embodiment, a super-cooled fluid (preferably a cryogenic fluid) is contacted with the lens or the mold half to release the lens from the mold half. The super cooled fluid creates a sudden temperature differential between the lens and the mold half that will break the bonding between the lens and the mold half. During, or immediately after, the removal of the lens from the mold half that is assisted by application of the super-cooled fluid, the step of pre-polymer extraction, solvent extraction and/or lens cleaning occurs according to the present invention. The release of a contact lens aided by a super-cooled fluid is set forth in corresponding U.S. Application No. 60/638,893 filed Dec. 22, 2004 entitled, “Pre-Polymer Extraction Using a Super-Cooled Fluid,” which is incorporated herein by reference in its entirety.

During lens release or after lens release, a cryogenic fluid is used in one embodiment of the present invention to increase the modulus of the contact lens. The temperature-induced hardening facilitates further processing of the ophthalmic lens.

In one embodiment, the period of time that the contacting occurs is a minimum of about 0.1 seconds to a maximum of about 20 seconds. Typically, the period of time effective to clean the molding tool is a minimum of about 0.1 seconds, about 0.5 seconds, about 1.0 seconds, about 2.0 seconds or about 5.0 seconds. Typically, the period of time effective to clean the molding tool is a maximum of about 20 seconds, about 15 seconds, about 10 seconds, about 5 seconds, about 3 seconds, about 2 seconds or about 1 second.

In another embodiment, the contacting occurs by immersing the contact lens in a bath containing the super-cooled fluid. Optionally, the contacting occurs by spraying the super-cooled fluid over the contact lens. In one embodiment, a measure of super-cooled fluid is contacted with the surface of the contact lens.

In still another embodiment, the super-cooled fluid is at a temperature below minus 40° C. Typically, the temperature is below minus 50° C., minus 60° C. or minus 70° C. Typically, the super-cooled fluid is a cryogenic fluid.

In another embodiment, the process is selected from the group consisting essentially of nitrogen, argon, helium or carbon dioxide. Preferably, the super-cooled fluid is an inert atmospheric gas. More preferably, the super-cooled fluid is nitrogen.

Edging/Polishing

While the contact lens still has an increased modulus due to the cooling of the contact lens, the lens edge is optionally smoothed and polished. The smoothing of the lens removes lens fragments or portions of the lens reservoir that might adhere to the lens following reservoir removal and/or lens release. The polishing of the lens is generally known in the art and results in a lens that has improved edge surface for comfort. However, after edging and polishing, the lens will have debris in contact with the lens and will require cleaning. The cleaning can occur with treatment by a cryogenic fluid a gas spray or when the contact lens is hydrated.

Surface Treatment/Lens Coating

This invention is applicable to a wide variety of surface modification processes. Generally, the method of this invention involves contacting a device surface with the surface modifying agent in the presence of a supercritical fluid. Representative supercritical fluids include supercritical carbon dioxide, supercritical nitrous oxide, supercritical methane, supercritical ethane, supercritical propane, supercritical butane, supercritical ethylene, supercritical fluoroform, and supercritical chloroform. Supercritical carbon dioxide is preferred. If desired, a liquid co-solvent may be included, especially an organic polar solvent or water. Specific examples include tetrahydrofuran (THF), acetonitrile, N,N-dimethyl formamide (DMF), as well as water.

The surface modifying agent may be attached to the lens surface by various means, including: formation of a covalent bond between a reactive group on the surface modifying agent and a complementary reactive group on or near the surface of the device; ionic bonding between such reactive groups; hydrogen bonding between such reactive groups; complexation between a surface modifying agent having a proton donating moiety and a device having relatively proton donating moieties; as well as other methods of attachment.

If desired, the surface modification may be facilitated by heating the surface modifying agent while contacted with the device surface. Alternately, if desired, a solution containing the surface modifying agent can be subjected to microwave radiation to facilitate attachment, as disclosed in U.S. application Ser. No. 60/436,229, filed Dec. 23, 2002 (Surface Treatment Utilizing Microwave Radiation, Docket No. P03072).

As an example, a coating layer may be formed according to the method described in U.S. Pat. No. 6,428,839 (Kunzler et al.), the disclosures of which is incorporated herein by reference. Generally, this method employs poly(acrylic) acid (PAA) surface complexation. Hydrogel contact lens copolymers containing polymerized hydrophilic monomers having relatively strong proton donating moieties, for example DMA or NVP, are treated with water-based solutions containing PAA or PAA co-polymers, acting as wetting agents, to render a lubricious, stable, highly wettable PAA-based surface coating. Alternately, other proton-donating wetting agents besides PAA-containing agents may be employed, although generally, coating materials containing carboxylic acid functionality are preferred. In this method, no additional oxidative surface treatment such as corona discharge or plasma oxidation is required. Surface coating materials include poly(vinylpyrrolidinone(VP)-co-acrylic acid(AA)), poly(methylvinylether-alt-maleic acid), poly(acrylic acid-graft-ethyleneoxide), poly(AA-co-methacrylic acid), poly(acrylamide-co-AA), poly(AA-co-maleic), and poly(butadiene-maleic acid). Particularly preferred polymers are characterized by acid contents of at least about 30 mole percent, preferably at least about 40 mole percent.

A supercritical fluid, for example, supercritical carbon dioxide, is employed as a solvent for the PAA material during the surface treatment (contacting) step of this method. If desired, a co-solvent may be included, for example, a solvent that readily solubilizes proton donating solubes such as carboxylic acids. Such solvents include tetrahydrofuran (THF), acetonitrile, N,N-dimethyl formamide (DMF), and water. The surface treatment solution is preferably acidified before the contact step. The pH of the solution is suitably less than 7, preferably less than 5 and more preferably less than 4. For a discussion of the theory underlying the role of pH in complexation reactions in general, see Advances in Polymer Science, published by Springer-Verlag, Editor H. J. Cantow, et al, V45, 1982, pages 17-63.

The surface treatment generally consists of immersing the lens in the PAA-containing solution. Optionally, following the surface contacting step, the lens with PAA may be heated by autoclaving, or subjected to microwave radiation, to facilitate further binding of the PAA to the lens surface.

The resultant contact lens has its external surface coated with the PAA coating layer, such coating being hydrophilic, wettable and lubricious.

As another example, this invention is applicable to the coating method described in U.S. application Ser. No. 10/187,056 (filed Jun. 28, 2002), the disclosure of which is incorporated herein by reference. Generally, this method involves surface modification of medical devices, particularly, IOLs, with-one or more reactive, hydrophilic polymers. The reactive, hydrophilic polymers are copolymers of at least one hydrophilic monomer and at least one monomer that contains reactive chemical functionality. The hydrophilic monomers can be aprotic types such as N,N-dimethylacrylamide and N-vinylpyrrolidone or protic types such as methacrylic acid and 2-hydroxyethyl methacrylate. The monomer containing reactive chemical functionality can be an epoxide-containing monomer, such as glycidyl methacrylate. The hydrophilic monomer and the monomer containing reactive chemical functionality are copolymerized at a desired molar ratio thereof. The hydrophilic monomer serves to render the resultant copolymer hydrophilic. The monomer containing reactive chemical functionality provides a reactive group that can react with the lens surface. In other words, this resultant copolymer contains the reactive chemical functionality that can react with complementary functional groups at or near the lens surface.

According to this embodiment of the present invention, the device is contacted with the reactive, hydrophilic copolymer in supercritical carbon dioxide.

As another example, a coating layer may be formed on the device surface according to the method described in U.S. Pat. No. 6,200,626, the disclosure of which is incorporated herein by reference. Generally, this method involves: (a) subjecting an oxidized surface of the lens to a plasma-polymerization deposition with an C1 to C10 saturated or unsaturated hydrocarbon to form a polymeric carbonaceous primary coating (or “carbon layer”) on the lens surface; and (b) grafting a hydrophilic monomer onto the carbon layer by free-radical polymerization of the monomers to form a hydrophilic, biocompatible, secondary polymeric coating. Specifically, according to this invention, the grafting of step (b) is conducted in a supercritical fluid.

Step (a) involves a standard plasma oxidation and deposition processes (also referred to as “electrical glow discharge processes”) to provide a thin, durable surface on the lens prior to the covalently bonded grafting of the hydrophilic polymeric coating in step (b). Such plasma processes are known in the art, and examples are provided in U.S. Pat. Nos. 4,143,949; 4,312,575; and 5,464,667, the disclosures of which are incorporated herein by reference. Plasma surface treatments involve passing an electrical discharge through a gas at low pressure. The electrical discharge may be at radio frequency (typically 13.56 MHz), although microwave and other frequencies can be used. Electrical discharges produce ultraviolet (UV) radiation, in addition to being absorbed by atoms and molecules in their gas state, resulting in energetic electrons and ions, atoms (ground and excited states), molecules and radicals. Thus, a plasma is a complex mixture of atoms and molecules in both ground and excited states, which reach a steady state after the discharge is begun. The circulating electrical field causes these excited atoms and molecules to collide with one another as well as the walls of the chamber and the surface of the material being treated.

The deposition of a coating from a plasma onto the surface of a material has been shown to be possible from high-energy plasmas without the assistance of sputtering (sputter-assisted deposition). Monomers can be deposited from the gas phase and polymerized in a low-pressure atmosphere (0.005 to 5 torr, preferably 0.01 to 1.0 torr) onto a substrate utilizing continuous or pulsed plasmas, suitably as high as about 1000 watts. A modulated plasma, for example, may be applied 100 milliseconds on then off. In addition, liquid nitrogen cooling has been utilized to condense vapors out of the gas phase onto a substrate and subsequently use the plasma to chemically react these materials with the substrate. However, plasmas generally do not require the use of external cooling or heating to cause the desired deposition.

Preferably, step (a) is preceded by subjecting the surface of the lens surface to a plasma oxidation reaction so as to more effectively bond the polymerized hydrocarbon coating to the lens and to resist delamination and/or cracking of the surface coating from the lens upon lens hydration. Thus, for example, if the lens is ultimately made from a hydrogel material that is hydrated (wherein the lens typically expands by ten to about twenty percent), the coating remains intact and bound to the lens, providing a more durable coating which is resistant to delamination and/or cracking. Such an oxidation of the lens may be accomplished in an atmosphere composed of an oxidizing media. It is preferred that a relatively “strong” oxidizing plasma is utilized for this oxidation, for example. ambient air drawn through a five percent (5%) hydrogen peroxide solution. As an example, plasma oxidation may be carried out at an electric discharge frequency of 13.56 Mhz, preferably between about 20 to 500 watts at a pressure of about 0.1 to 1.0 torr, preferably for about 10 seconds to about 10 minutes or more, more preferably about 1 to 10 minutes. The contact lens can alternatively be pretreated by providing an aminated surface, by subjecting the lens to an ammonia or an aminoalkane plasma. Those skilled in the art will recognize other methods of improving or promoting adhesion for bonding of the subsequent carbon layer. For example, plasma with an inert gas may also improve bonding.

Then, in step (a), a thin hydrocarbon coating is deposited on the lens, and in step (b), the carbon surface is exposed to, and-reacted with the hydrophilic monomer, or mixture of monomers including the hydrophilic monomer, under free-radical polymerization conditions, resulting in a hydrophilic polymer coating attached to the carbon surface.

In step (a), the lens surface is subjected to the plasma polymerization reaction in a hydrocarbon atmosphere to form a polymeric surface on the lens. Any hydrocarbon capable of polymerizing in a plasma environment may be utilized; however, the hydrocarbon generally should be in a gaseous state during polymerization and have a boiling point below about 200° C. at one atmosphere. Preferred hydrocarbons include aliphatic compounds having from 1 to about 15 carbon atoms, including both saturated and unsaturated aliphatic compounds. Examples include, but are not limited to, C₁ to C₁₅, preferably C₁ to C₁₀ alkanes, alkenes or alkynes such as methane, ethane, propane, butane, pentane, hexane, ethylene, propylene, butylene, cyclohexane, pentene, acetylene. Also, C₁ to C₈ aromatics such as benzene, styrene, methylstyrene and the like may be employed. As is known in the art, such hydrocarbon groups may be unsubstituted or substituted so long as they are capable of forming a plasma. Various combinations of different hydrocarbons may also be used.

The use of C₁ to C₄ hydrocarbons for the purpose of carbon-coating substrates is advantageous for its controllability in terms of thickness, deposition rate, hardness, etc. However, with respect to hydrogel materials, the C₄ to C₈ hydrocarbons (for example, butane, butene, isobutylene, and 1,3-butadiene) are advantageous, due to being relatively more flexible than coatings made from C₁ to C₃ hydrocarbons such as methane. Diolefins such as 1,3-butadiene or isoprene are particularly advantageous, resulting in coatings that are both flexible and expandable in water. More flexible coatings are especially preferred for “high-water” contact lenses that expand considerably upon hydration.

The hydrocarbon coating can be deposited from plasma, for example, in a low-pressure atmosphere (about 0.001 to 5 torr) at a radio frequency of 13.56 Mhz, at about 10 to 1000 watts, preferably 20-400 watts in about 30 seconds to 10 minutes or more, more preferably 30 seconds to 3 minutes. Other plasma conditions may be suitable as will be understood by the skilled artisan, for example, using pulsed plasma.

If the hydrocarbon coating provided is too thick, it can cause a haziness, resulting in a cloudy lens. Furthermore, excessively thick coatings can interfere with lens hydration due to differences in expansion between the lens and the coating, causing the lens to rip apart. Therefore, the thickness of the hydrocarbon layer should be less than about 500 Angstroms, preferably between about 25 and 500 Angstroms, more preferably 50 to 200 Angstroms, as determined by XPS analysis.

To form the polymer coating in step (b), an initiator may be employed to cause the ethylenically-unsaturated monomer to react with the surface. In any case, the carbon layer must be rendered reactive (activated) to promote covalent attachment. One advantage of diolefins to form the carbon layer is that unsaturated sites for the initiation of graft polymerization are already present. When employing other hydrocarbons to form the carbon layer, an activator or initiator may be employed to speed the free-radical graft polymerization of the surface. Alternately, conventional techniques for the initiation of graft polymerization may be applied to the carbon layer to create peroxy or other functional groups that can also initiate graft polymerization. For example, it is known in the art that various vinyl monomers can be graft polymerized onto polymer substrates which have been first treated with ionizing radiation in the presence of oxygen or with ozone to form peroxy groups on the surface of said substrate. See U.S. Pat. Nos. 3,008,920 and 3,070,573, for instance, for ozonization of the substrate. Alternatively, a carbon layer formed by plasma may already contain radicals that when exposed to air, form peroxide groups that decompose to oxygen radicals. Additional plasma/corona treatment is also capable of forming radicals for reaction with ethylenically-unsaturated monomers or polymers. Still another way to promote graft polymerization is to plasma treat the substrate, for example with argon or helium in plasma form, to form free radicals on its outmost surfaces, then contacting these radicals with oxygen to form hydroperoxy groups from the free radicals, followed by graft polymerizing ethylenically unsaturated monomers onto the surface.

The grafting polymer may be formed by using an aqueous solution of the ethylenically unsaturated monomer or mixture of monomers capable of undergoing graft addition polymerization onto the surface of the substrate. In those cases where one or more of the monomers is not appreciably soluble in water, a cosolvent such as tert-butyl alcohol may be used to enhance the solubility of the monomer in the aqueous graft polymerization system. The graft polymer may be the reaction product of a mixture of monomers comprising one or more hydrophilic monomers, including the aforementioned hydrophilic monomers employed as hydrogel copolymer lens-forming monomers. Specific examples of hydrophilic monomers for grafting to the carbon layer include aprotic types: acrylamides, such as N,N-dimethylacrylamide (DMA); vinyl lactams, such as N-vinylpyrrolidinone (NVP); and (meth)acrylated poly(alkylene oxides) such as methoxypolyoxyethylene methacrylates. Other specific examples include protic types: (meth)acrylic acid; and hydroxyalkyl(meth)acrylates, such as hydroxyethyl methacrylate (Hema). Hydrophilic monomers may also include zwitterions such as N,N-dimethyl-N-methacryloxyethyl-N-(3-sulfopropyl)-ammonium betain (SPE) and N,N-dimethyl-N-methacrylamidopropyl-N-(3-sulfopropyl)-ammonium betain (SPP). Optionally, some hydrophobic monomers may also be included with the hydrophilic monomer to impart desired properties such as resistance to lipid or protein deposition. Examples of hydrophobic monomers are alkyl methacrylate, fluorinated alkyl methacrylates, long-chain acrylamides such as octyl acrylamide, and the like. This monomeric mixture may be applied to the contact lens by dipping the front surface of the lens in the monomer mixture, or by spraying this mixture on the lens surface.

The graft polymerization of step (b) is carried out in a supercritical fluid such as supercritical carbon dioxide. A co-solvent may also be used to dissolve the reactive monomers. Suitable solvents are those which dissolve the monomers, including: water; alcohols such as lower alkanols, for example, ethanol and methanol; carboxamides such as dimethylformamide; dipolar aprotic solvents such as dimethyl sulfoxide or methyl ethyl ketone; ketones such as acetone or cyclohexanone; hydrocarbons such as toluene; ethers such as THF, dimethoxyethane or dioxane; halogenated hydrocarbons such as trichloroethane, and also mixtures of suitable solvents, for example mixtures of water and an alcohol, for example a water/ethanol or water/methanol mixture. Determination of reactivity ratios for copolymerization are disclosed in Odian, Principles of Polymerization, 2nd Ed., John Wiley & Sons, p. 425-430 (1981), the disclosure of which is incorporated by reference herein. Then, the lens and solution may be exposed to heat or microwave radiation to facilitate the graft polymerization.

To further promote the free-radical grafting, the lens substrate may optionally be immersed in a first solution containing an initiator followed by a immersion of the substrate in a second solution containing the hydrophilic monomer or mixture thereof. Typical polymerization initiators include free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobis-isobutyronitrile (AIBN). The curing process will of course depend upon the initiator used and the physical characteristics of the comonomer mixture such as viscosity. If an initiator is employed, it is typically present at a level within the range of 0.01 to 2 weight percent of the monomer mixture.

As another example, the coating layer may be formed according to the method described in U.S. Pat. No. 6,630,243 or PCT publication WO 00/71613), the disclosures of which are incorporated herein by reference. Generally, this method involves: (a) subjecting an oxidized surface of the lens to a plasma-polymerization deposition with an C₁ to C₁₀ saturated or unsaturated hydrocarbon to form a polymeric carbonaceous primary coating (or “carbon layer”) on the lens surface; (b) forming reactive functionalities on the surface of the carbon layer; and (c) attaching hydrophilic polymer chains to the carbon layer by reacting the reactive functionalities on the carbon layer with complementary isocyanate or ring-opening reactive functionalities along a reactive hydrophilic polymer. More specifically, the attachment of the hydrophilic polymer chains to the carbon layer is conducted in a supercritical fluid.

Step (a) of this coating process is similar to step (a) in the immediately aforementioned coating process, and similarly, is preferably preceded by subjecting the surface of the lens to a plasma-oxidation reaction so as to more effectively bond the polymerized hydrocarbon coating to the lens. In step (b), reactive functionalities are formed on the surface of the carbon layer to form the point of attachment for hydrophilic polymer chains. In step (c), the functionalized carbon surface is exposed to, and reacted with, hydrophilic reactive polymers, resulting in hydrophilic polymer chains attached to the carbon surface, rendering the carbon coating of step (a) hydrophilic. Any complementary reactive functionalities on the hydrophilic reactive polymer that remain unreacted, after attachment to the carbon surface at one or more locations, may be hydrolyzed as explained below. Preferably, on average the hydrophilic polymers become attached to the substrate surface at a plurality of points, therefore forming one or more loops on the surface.

Various methods are known in the art to attach a polymer chain to a carbon layer, including plasma oxidation or other means to provide surface reactive functional groups that can react with the polymer. Preferably, a nitrogen-containing gas is used to aminate, or form amine groups on, the carbon layer. However, oxygen or sulfur containing gases may alternately be used to form oxygen or sulfur containing groups, for example hydroxy or sulfide groups, on the carbon layer. Thus, the carbon layer is rendered reactive (functionalized) to promote the covalent attachment of the hydrophilic polymer to the surface.

To create an aminated carbon layer, the oxidation preferably utilizes a gas composition comprising an oxidizing media such as ammonia, ethylene diamine, C₁ to C₈ alkyl amine, hydrazine, or other oxidizing compounds. Preferably, the oxidation of the hydrocarbon layer is performed for a period of about 10 seconds to 10 minutes or more, more preferably 1 to 10 minutes, a discharge frequency of 13.56 Mhz at about 10 to 1000 watts, preferably 20 to 500 watts and about 0.1 to 1.0 torr.

The hydrophilic polymer, which is attached to the reactive functionalities on the carbon coating, may be the reaction product of monomers comprising one or more non-reactive hydrophilic monomers and one or more reactive functional monomers. In this case, the reactive functional monomeric unit will react with complementary reactive functionalities on the surface provided by the previous plasma oxidation. Such reactive functional monomers may include monomers containing one or more of the following groups: cyanate (—CNO); or various ring-opening reactive groups, for example, azlactone, epoxy, acid anhydrides, and the like.

The hydrophilic reactive polymers may be homopolymers or copolymers comprising reactive monomeric units that contain either an isocyanate or a ring-opening reactive functionality optionally. Although these reactive monomeric units may also be hydrophilic, the hydrophilic reactive polymer may also be a copolymer of reactive monomeric units copolymerized with one or more of various non-reactive hydrophilic monomeric units. Lesser amounts of hydrophobic monomeric units may optionally be present in the hydrophilic polymer, and in fact may be advantageous in providing a thicker coating by promoting the aggregation of the hydrophilic reactive polymer in solution. The ring-opening monomers include azlactone-functional, epoxy-functional and acid-anhydride-functional monomers.

Mixtures of hydrophilic reactive polymers may be employed. For example, the hydrophilic polymer chains attached to the carbonaceous layer may be the result of the reaction of a mixture of polymers comprising (a) a first hydrophilic reactive polymer having reactive functionalities in monomeric units along the hydrophilic polymers complementary to reactive functionalities on the carbonaceous layer and, in addition, (b) a second hydrophilic reactive polymer having supplemental reactive functionalities that are reactive with the first hydrophilic reactive polymer. A mixture comprising an epoxy-functional polymer with an acid-functional polymer, either simultaneously or sequentially applied to the substrate to be coated, have been found to provide relatively thick coatings.

Preferably the hydrophilic reactive polymers comprise 1 to 100 mole percent of reactive monomeric units, more preferably 5 to 50 mole percent, most preferably 10 to 40 mole percent. The polymers may comprise 0 to 99 mole percent of non-reactive hydrophilic monomeric units, preferably 50 to 95 mole percent, more preferably 60 to 90 mole percent (the reactive monomers, once reacted may also be hydrophilic, but are by definition mutually exclusive with the monomers referred to as hydrophilic monomers which are non-reactive). Other monomeric units which are hydrophobic optionally may also be used in amounts up to about 35 mole percent, preferably 0 to 20 mole percent, most preferably 0 to 10 mole percent. Examples of hydrophobic monomers are alkyl methacrylate, fluorinated alkyl methacrylates, long-chain acrylamides such as octyl acrylamide, and the like. Hydrophilic monomers may be aprotic types, such as acrylamides vinyl lactones, and poly(alkylene oxides), or may be protic types such as (meth)acrylic acid or hydroxyalkyl(meth)acrylates. Hydrophilic monomers may also include zwitterions.

The weight average molecular weight of the hydrophilic reactive polymer may suitably range from about 200 to 1,000,000, preferably from about 1,000 to 500,000, most preferably from about 5,000 to 100,000.

As mentioned above, the hydrophilic reactive polymer may comprise monomeric units derived from azlactone-functional, epoxy-functional and acid-anhydride-functional monomers. For example, an epoxy-fuinctional hydrophilic reactive polymer for coating a lens can be a copolymer containing glycidyl methacrylate (GMA) monomeric units which will react with amine reactive functionalities or the like on the carbon layer. Preferred examples of anhydride-functional hydrophilic reactive polymers comprise monomeric units derived from monomers such as maleic anhydride and itaconic anhydride.

In general, epoxy-functional reactive groups or anhydride-functional reactive groups in the hydrophilic reactive polymer react with the primary amine (—NH₂) groups or other reactive functionalities formed by plasma-oxidation on the carbon layer. Although amine reactive functionalities are preferred, oxygen-containing groups may be employed, preferably in the presence of an acidic catalyst such as 4-dimethylaminopyridine, to speed the reaction at room temperature, as will be understood by the skilled chemist. In general, azlactone or isocyanate-functional groups in the hydrophilic reactive polymers may similarly react with amines or hydroxy radicals, or the like, on the carbon layer.

Preferably, preformed (non-polymerizable)hydrophilic polymers containing repeat units derived from at least one ring-opening monomer or isocyanate-containing monomer are covalently reacted with reactive groups on the surface of the medical device such as a contact lens substrate. Typically, the hydrophilic reactive polymers are attached to the substrate at one or more places along the chain of the polymer. After attachment, any unreacted reactive functionalities in the hydrophilic reactive polymer may be hydrolyzed to a non-reactive moiety.

The hydrophilic reactive polymers are synthesized in a known manner from the corresponding monomers (the term monomer again also including a macromonomer) by a polymerization reaction customary to the person skilled in the art. Typically, the hydrophilic reactive polymers or chains are formed by: (1) mixing the monomers together; (2) adding a polymerization initiator; (3) subjecting the monomer/initiator mixture to a source of ultraviolet or actinic radiation and curing said mixture. Typical polymerization initiators include free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobis-isobutyronitrile (AIBN). Ultraviolet free-radical initiators illustrated by diethoxyacetophenone can also be used. The curing process will of course depend upon the initiator used and the physical characteristics of the comonomer mixture such as viscosity. In any event, the level of initiator employed will vary within the range of 0.01 to 2 weight percent of the mixture of monomers.

The polymerization to form the hydrophilic reactive polymer can be carried out in the presence of a solvent. Suitable solvents include water, alcohols such as lower alkanols, for example, ethanol and methanol; carboxamides such as dimethylformamide; dipolar aprotic solvents such as dimethyl sulfoxide or methyl ethyl ketone; ketones such as acetone or cyclohexanone; hydrocarbons such as toluene; ethers such as THF, dimethoxyethane or dioxane; halogenated hydrocarbons such astrichloroethane, and also mixtures of suitable solvents, for example mixtures of water and an alcohol, for example a water/ethanol or water/methanol mixture.

The carbon-coated contact lens is contacted with the hydrophilic reactive polymer in the presence of supercritical fluid. The lens may be immersing in a solution containing the polymer while in the supercritical fluid environment.

As indicated above, this coating method involves attaching reactive hydrophilic polymers to a functionalized carbon coating, which polymers comprise isocyanate-containing monomeric units or ring-opening monomeric units. The ring-opening reactive monomer may be an azlactone group represented by the following formula: 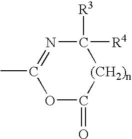
wherein R³ and R⁴ independently can be an alkyl group having 1 to 14 carbon atoms, a cycloalkyl group having 3 to 14 carbon atoms, an aryl group having 5 to 12 ring atoms, an arenyl group having 6 to 26 carbon atoms, and 0 to 3 heteroatoms non-peroxidic selected from S, N, and O, or R³ and R⁴ taken together with the carbon to which they are joined can form a carbocyclic ring containing 4 to 12 ring atoms, and n is an integer 0 or 1. Such monomeric units are disclosed in U.S. Pat. No. 5,177,165 to Valint et al.

The ring structure of such reactive functionalities is susceptible to nucleophilic ring-opening reactions with complementary reactive functional groups on the surface of the carbon layer or substrate being treated. For example, the azlactone functionality can react with primary amines, hydroxyl radicals or the like formed by plasma oxidation of the carbon layer, as mentioned above, to form a covalent bond between the substrate and the hydrophilic reactive polymer at one or more locations along the polymer. A plurality of attachments can form a series of polymer loops on the substrate, wherein each loop comprises a hydrophilic chain attached at both ends to the substrate.

Azlactone-functional monomers for making the hydrophilic reactive polymer can be any monomer, prepolymer, or oligomer comprising an azlactone functionality of the above formula in combination with a vinylic group on an unsaturated hydrocarbon to which the azlactone is attached. Preferably, azlactone-functionality is provided in the hydrophilic polymer by 2-alkenyl azlactone monomers. The 2-alkenyl azlactone monomers are known compounds, their synthesis being described, for example, in U.S. Pat. Nos. 4,304,705; 5,081,197; and 5,091,489 (all Heilmann et al.) the disclosures of which are incorporated herein by reference. Suitable 2-alkenyl azlactones include:
2-ethenyl-1,3-oxazolin-5-one,
2-ethenyl-4-methyl-1,3-oxazolin-5-one,
2-isopropenyl-1,3-oxazolin-5-one,
2-isopropenyl-4-methy 1-1,3-oxazolin-5-one,
2-ethenyl-4,4-dimethyl-1,3-oxazolin-5-one,
2-isopropenyl-4,-dimethyl-1,3-oxazolin-5-one,
2-ethenyl-4-methyl-ethyl-1,3-oxazolin-5-one,
2-isopropenyl-4-methyl-4-butyl-1,3-oxazolin-5-one,
2-ethenyl-4,4-dibutyl-1,3-6xazolin-5-one,
2-isopropenyl-4-methyl-4-dodecyl-1,3-oxazolin-5-one,
2-isopropenyl-4,4-diphenyl-1,3-oxazolin-5-one,
2-isopropenyl-4,4-pentamethylene-1,3-oxazolin-5-one,
2-isopropenyl-1-4,4-tetramethylene-1,3-oxazolin-5-one,
2-ethenyl-4,4-diethyl-1,3-oxazolin-5-one,
2-ethenyl-4-methyl-4-nonyl-1,3-oxazolin-5-one,
2-isopropenyl-methyl-4-phenyl-1,3-oxazolin-5-one,
2-isopropenyl-4-methyl-4-benzyl-1,3-oxazolin-5-one, and
2-ethenyl-4,4-pentamethylene-1,3-oxazolin-5-one.

More preferably, the azlactone monomers are a compound represented by the following general formula: 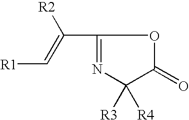
where R¹ and R² independently denote a hydrogen atom or a lower alkyl radical with one to six carbon atoms, and R³ and R⁴ independently denote alkyl radicals with one to six carbon atoms or a cycloalkyl radical with five or six carbon atoms. Specific examples include 2-isopropenyl-4,4-dimethyl-2-oxazolin-5-one (IPDMO), 2-vinyl-4,4-dimethyl-2-oxazolin-5-one (VDMO), spiro-4′-(2′-isopropenyl-2′-oxazolin-5-one) cyclohexane (IPCO), cyclohexane-spiro-4′-(2′-vinyl-2′-oxazol-5′-one) (VCO), and 2-(-1-propenyl)-4,4-dimethyl-oxazol-5-one (PDMO) and the like.

As indicated above, these ring-opening compounds can be copolymerized with hydrophilic and/or hydrophobic comonomers to form hydrophilic reactive polymers. After attachment to the desired substrate, any unreacted oxazolinone groups may then be hydrolyzed in order to convert the oxazolinone components into amino acids. In general, the hydrolysis step will follow the general reaction of:

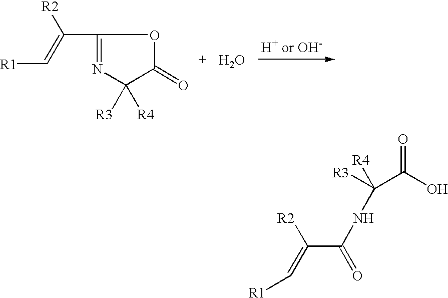

The carbon-carbon double bond between the R¹ and R² radicals is shown unreacted, but the reaction can take place when copolymerized into a polymer.

Non-limiting examples of comonomers useful to be copolymerized with azlactone functional moieties to form the hydrophilic reactive polymers used to coat a medical device include those mentioned above, preferably dimethylacrylamide, hydroxyethyl methacrylate (HEMA), and/or N-vinylpyrrolidone.

Such azlactone-functional monomers can be copolymerized with other monomers in various combinations of weight percentages. Using a monomer of similar reactivity ratio to that of an azlactone monomer will result in a random copolymer. Determination of reactivity ratios for copolymerization are disclosed in Odian, Principles of Polymerization, 2nd Ed., John Wiley & Sons, p. 425-430 (1981), the disclosure of which is incorporated by reference herein. Alternatively, use of a comonomer having a higher reactivity to that of an azlactone will tend to result in a block copolymer chain with a higher concentration of azlactone-functionality near the terminus of the chain.

Although not as preferred as monomers, aziactone-functional prepolymers or oligomers having at least one free-radically polymerizable site can also be utilized for providing azlactone-functionality in the hydrophilic reactive polymer according to the present invention. Azlactone-functional oligomers, for example, are prepared by free radical polymerization of azlactone monomers, optionally with comonomers as described in U.S. Pat. Nos. 4,378,411 and 4,695,608, incorporated by reference herein. Non-limiting examples of azlactone-functional oligomers and prepolymers are disclosed in U.S. Pat. Nos. 4,485,236 and 5,081,197 and European Patent Publication 0 392 735, all incorporated by reference herein.

Alternately, the ring-opening reactive group in the hydrophilic reactive polymer may be an epoxy functionality. The preferred epoxy-functional monomer is an oxirane-containing monomer such as glycidyl methacrylate, 4-vinyl-1-cyclohexene-1,2-epoxide, or the like, although other epoxy-containing monomers may be used. Exemplary comonomers are N,N-dimethylacrylamide and fluorinated monomers such as octafluoropentylmethacrylate.

As another example, the coating layer may be formed according to the method described in U.S. Pat. No. 6,213,604, the disclosure of which is incorporated herein by reference. Generally, this method involves: (a) subjecting the surface of the lens to a plasma oxidation reaction to create oxygen or nitrogen containing functional groups on the surface of the lens, in order to promote adhesion of the subsequent carbon coating; (b) subjecting the oxidized surface of the lens to a plasma polymerization deposition with a gas made from a diolefinic compound having 4 to 8 carbon atoms, in the absence of oxygen, thus forming a carbon layer on the surface on the lens; and (c) graft polymerizing a hydrophilic polymer to the lens surface. According to this invention, the graft polymerization step (c) is conducted in a supercritical fluid.

This method utilizes standard plasma oxidation and deposition processes (also referred to as “electrical glow discharge processes”) to provide a thin, durable, hydrophilic surface on the contact lens. With an oxidizing plasma, e.g., O₂ (oxygen gas), water, hydrogen peroxide, air, etc., ammonia and the like, the plasma tends to etch the surface of the lens, creating radicals and oxidized functional groups. When used as the sole surface treatment, such oxidation renders the surface of a lens more hydrophilic; however, the coverage of such surface treatment may be incomplete and the bulk properties of the silicone material remain apparent at the surface of the lens (e.g., silicone molecular chains adjacent the lens surface are capable of rotating, thus exposing hydrophobic groups to the outer surface). Hydrocarbon plasmas, on the other hand, deposit a thin carbon layer (e.g., from a few Angstroms to several thousand Angstroms thick) upon the surface of the lens, thereby creating a barrier between the underlying silicone materials and the outer lens surface. Following the deposition of a carbon layer on the lens to form a barrier, a further plasma oxidation will render the surface more hydrophilic. Thus, the surface of the lens is first subjected to a plasma oxidation, prior to subsequent plasma polymerization to deposit a carbon layer, followed by a final plasma oxidation. The initial plasma oxidation in step (a) prepares the surface of the lens to bind the carbon layer that is subsequently deposited by plasma polymerization on the lens in step (b). This carbon layer or coating provides relatively complete coverage of the underlying silicone material.

Step (c) involves graft polymerizing a hydrophilic polymer to the lens surface so as to render the carbon coating of step (b) hydrophilic. The aforementioned hydrophilic polymers may be employed. In this step, the lens is contacted with the hydrophilic polymer in an environment of supercritical fluid.

Lens Cleaning/Pre-Polymer Extraction

A cryogenic fluid is used in one embodiment of the present invention to clean the lens of debris and extract pre-polymer and/or solvent. Pre-polymer and or solvent is extracted from a polymer lens by contacting the lens with a super-cooled solvent for a period of time sufficient to extract pre-polymer from the polymer lens.

In one embodiment, the period of time is a minimum of about 0.1 seconds to a maximum of about 20 seconds. Typically, the period of time effective to clean the molding tool is a minimum of about 0.1 seconds, 0.5 seconds, 1.0 seconds, 2.0 seconds or 5.0 seconds. Typically, the period of time effective to clean the molding tool is a maximum of about 20 seconds, about 15 seconds, about 10 seconds, about 5 seconds, about 3 seconds, about 2 seconds or about 1 second.

In another embodiment, the contacting occurs by immersing the contact lens in a bath containing the super-cooled fluid. Optionally, the contacting occurs by spraying the super-cooled fluid over the contact lens.

In still another embodiment, the super-cooled fluid is at a temperature below minus 40° C. Typically, the temperature is below minus 50° C., minus 60° C. or minus 70° C. Typically, the super-cooled fluid is a cryogenic fluid.

In another embodiment, the process is selected from the group consisting essentially of nitrogen, argon, helium or carbon dioxide. Preferably, the super-cooled fluid is an inert atmospheric gas. More preferably, the super-cooled fluid is nitrogen.

Typically, the extraction of pre-polymers occurs after the contact lens is removed from a mold that forms the contact lens. Optionally, the extraction of pre-polymers occurs while the lens is being released from a mold that forms the contact lens.

Washing and Hydration

After the inspection stage, the lenses proceed to a washing and/or hydration stage depending upon the type of lens. Typically, the lenses are supported on a carrier that supports a plurality of lenses in separate compartments e.g. 16, 32 etc. Optionally, the final packaging is used as the carrier during the washing and hydration step. In either instance, each lens is washed with purified water or in the case of hydrogel lenses hydrated with purified water until it has expanded to its full dimensions. Alternatively, the lens is washed or hydrated with a buffered saline solution in one or more washing steps. Water (or buffered saline solution) is extracted from the polymer matrix of the lens. Fresh water added to rinse the lenses. The lenses may be subjected to several rinses by extraction and addition of purified water. Preferably, a check is made to ensure the presence of a lens in a compartment after each extraction of water. It is believed that the previous step of pre-polymer extraction with a super-cooled fluid will reduce the number of stages of rinses with water or buffered saline solution.

Transferred from the carrier into containers or blisters for final packaging the identity of the lenses is monitored via the carrier indicator. For example, the carrier identifier may be scanned as the carrier enters a processing station which will trigger the computer to provide the necessary information for printing a label or information directly on the lid stock which is applied to feel the blisters or containers. In general, applying a lid stock which is heat-sealed to the perimeter of the blister or container seals the blisters or containers.

Suitable lid stock comprises a laminate of metal foil on a polypropylene film. The lid stock may be printed e.g. by laser etching before or after its application to the container or blister. Alternatively, a label may be printed and applied to the lid stock before or after its application. The information printed on the lid stock or label may provide information for use by the end user or may be a machine readable identifier e.g. bar code, matrix code etc. to be used in later packaging operations. The labeling will provide sufficient information such that the lens in each blister or container may be identified in terms of its prescription and SKU, if necessary by interrogating the computer database. Thus, product integrity is ensured from inspection of the individual lens to its packaging in the blister or container.

Prior to application of the lid stock each blister or container is checked for the presence of a lens. After application of the lid stock the container or blister is examined for leaks and bad seals.

Thereafter, the packaged lenses are subjected to sterilization. The blisters or containers may be transferred to a tray or carrier for passage through the sterilization stage. The carrier is provided with a carrier indicator which is read and the information recorded in the computer memory so that the identity of the lenses and SKU is associated with the carrier indicator information.

After sterilization the lenses may be stored in a warehouse and cartoned and labeled in response to a specific order. Alternatively, the lenses may be cartoned and labeled to fulfill an order or for stockpiling ready for future orders.

Inspection

Optionally, the lenses are inspected to identify lenses with optical defects. The inspection can be manual or automatic. If a lens fails the inspection test, it is deposited in a reject bin. If the lens passes the inspection test, the lens can be conveyed to the next processing step.

What is claimed is:

1. A process for finishing a contact lens comprising the steps of:
providing a contact lens;
contacting the contact lens with a super-cooled fluid to increase the modulus of the contact lens; and
finishing the edge of the contact lens.

2. The process of claim 1, wherein the pre-polymer is a silicone containing pre-polymer.

3. The process of claim 1, wherein the pre-polymer is a hydrophilic pre-polymer.

4. The process of claim 1, wherein at least one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

5. The process of claim 1, wherein the contacting occurs for a period of time that is a minimum of about 0.1 seconds to a maximum of about 20 seconds.

6. The process of claim 1, wherein the contacting occurs by immersing the contact lens in a bath containing the super-cooled fluid.

7. The process of claim 1, wherein the contacting occurs by spraying the super-cooled fluid over the contact lens.

8. The process of claim 1, wherein the super-cooled fluid is at a temperature below minus 40° C.

9. The process of claim 1, wherein the super-cooled fluid is selected from the group consisting essentially of nitrogen, argon, helium, air and carbon dioxide.

10. The process of claim 1, wherein the step of contacting occurs after the contact lens is removed from a mold that forms the contact lens.

11. The process of claim 1, wherein the step of contacting occurs while the lens is being released from a mold that forms the contact lens.

12. A process for making a contact lens, the process comprising the steps of:
providing a mold comprising an anterior mold half and a posterior mold half;
filing the mold with a pre-polymer;
curing the pre-polymer to form a contact lens;
separating the anterior mold half from the posterior mold half;
removing the contact lens from one of the anterior mold half or the posterior mold half;
contacting the contact lens with a cryogenic solvent to increase the modulus of the contact lens; and
performing an additional dry processing step selected from the group consisting of coating the lens or surface treating the lens.

13. The process of claim 12, wherein the additional dry processing step comprises finishing the edge of the contact lens.

14. The process of claim 12, wherein the additional dry processing step comprises surface treating the contact lens.

15. The process of claim 12, wherein the additional dry processing step comprises coating the contact lens.

16. The process of claim 12, wherein the pre-polymer is a silicone containing pre-polymer.

17. The process of claim 12, wherein the pre-polymer is a hydrophilic pre-polymer.

18. The process of claim 12, wherein at lest one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

19. The process of claim 12, wherein the contacting occurs for a period of time that is a minimum of about 0.1 seconds to a maximum of about 20 seconds.

20. The process of claim 12, wherein the contacting occurs by immersing the contact lens in a bath containing the super-cooled fluid.

21. The process of claim 12, wherein the contacting occurs by spraying the super-cooled fluid over the contact lens.

22. The process of claim 12, wherein the super-cooled fluid is at a temperature below minus 40° C.

23. The process of claim 12, wherein the super-cooled fluid is selected from the group consisting essentially of nitrogen, argon, helium, air and carbon dioxide.

24. The process of claim 12, wherein the step of contacting occurs after the contact lens is removed from a mold that forms the contact lens.

25. The process of claim 12, wherein the step of contacting occurs while the lens is being released from a mold that forms the contact lens.

26. The process of claim 12, wherein the step of contacting the contact lens occurs before the step of removing but after the step of curing.

27. A process for manufacturing a contact lens, comprising the steps of:
forming the contact lens in a mold;
removing the contact lens from the mold;
contacting the contact lens with a cryogenic solvent to increase the modulus of the contact lens; and
performing additional dry processing steps.

28. The process of claim 27, wherein the additional dry processing step comprises coating the contact lens.

29. The process of claim 27, wherein the pre-polymer is a silicone containing pre-polymer.

30. The process of claim 27, wherein the pre-polymer is a hydrophilic pre-polymer.
